(19) United States
(12) Patent Application Publication
(10) Pub. No.: US 2007/0202229 A1
(43) Pub. Date: Aug. 30, 2007

(54) Method And Arrangement For Portion Cutting Of Food Items, And Use Of A Cutting Device In The Arrangement

(75) Inventor: Ulrich Carlin Nielsen, Ry (DK)

Correspondence Address: PEARNE & GORDON LLP, 1801 EAST 9TH STREET, SUITE 1200, CLEVELAND, OH, 44114-3108, US

(73) Assignee: SCANVAEGT INTERNATIONAL A/S, Arhus N (DK)

(21) Appl. No.: 10/599,602

(22) PCT Filed: Mar. 22, 2005
(86) PCT No.: PCT/DK05/00194

§ 371 Date: Nov. 9, 2006

(30) Foreign Application Priority Data
Apr. 5, 2004 (DK) PA200400552

(51) Int. Cl. A23P 1/00

(52) U.S. Cl. 426/518

(57) ABSTRACT

The invention relates to a method and an arrangement for portion cutting of food items, especially meat products, into pieces of predetermined shape, such as quadratic meat pieces, where the method comprises the following steps: feeding of the items in a first cutting device in a first feeding direction, in which device the items are cut into strips in a cutting unit, transfer of the strips from the first cutting device to at least one additional cutting device with another feeding direction different from that of the first feeding direction, and cutting in at least the one additional cutting device, in which by a cutting unit the strips are cut into pieces of predetermined shape, such as quadratic meat pieces. Furthermore, there is disclosed the use of a cutting device in an arrangement according to the invention.

The invention relates to a method and an arrangement for the portion cutting of food items, especially meat products, in pieces of predetermined shapes, such as quadratic pieces of meat.

Within the foodstuffs industry, demands are made from time to time concerning special cuts of meat, an example of these being special portion cuts of poultry. The starting point for the meat cuts is e.g. de-boned leg and breast meat, where the remaining meat and skin are made “smooth” in one piece. Today, the cutting is carried out manually by persons who often have years of training, and the cut portions consists mainly of substantially quadratic pieces with a relatively precise size/weight.

Raw thigh and breast meat of chicken passes through the following processes:
1. Manual removal of bone and “smoothing-out” of the initial piece.
2. Manual fine-trimming of the initial piece, so that it is substantially whole and without loose skin, fat or meat shreds.
3. Manual portion cutting into quadratic pieces with a weight of around 20-25 g is carried out “by eye” following experience, and by removing parts of the meat which are not “regular”.

This special portion cutting has hitherto only been performed manually, and it has shown that this gives rise to considerable disadvantages, especially in the third part of the process. In the first place, an experienced worker can produce only relatively few pieces of meat with acceptable size/weight within a given period of time, and secondly the meat wastage for an experienced cutter lies at around 17-20%, and considerably higher for an inexperienced cutter.

The international patent application WO94/26479 describes an apparatus for portion cutting of relatively regular food items, such as bone-free meat products, boiled ham, sausages etc. into uniform cubes, where the apparatus comprises two successively arranged cutting units. The first unit cuts in slices, and via a rotating knife the second unit cuts the slices into strips, which immediately afterwards are cut by a number of parallel knives into smaller, uniform cubes. The cubes are generally used as components in ready-prepared dishes, including toppings for pizza, and are therefore of relatively small size.

This known apparatus, and other known apparatuses of the same type which comprise a number of stationary parallel knives, are limited in their use, the reason being that they are not suitable for the cutting-up of food items in larger, more complex portions, since there is no possibility for adjustment of the cutting-up individually to the contour of the initial item, i.e. a varying breadth and thickness of the initial pieces and/or irregular surfaces on the food item.

Thus with the manual cutting the problem exists in the low speed with which the pieces are cut-up, even by a trained worker, in the relatively long time which is used in the training of a worker, and in the high degree of meat wastage, i.e. seen as a whole, the low output achieved with manual cutting.

It is in light of this that the object of the present invention is to make it possible for a cutting-up into special portions to be carried out in a substantially quicker and more accurate manner than the present manual cutting, whereby said portion cutting also results in less meat wastage.

Furthermore, it is an object of the invention to enable other more complex, larger portion cutting of a food item.

This object is achieved by a method and an arrangement for portion cutting of food items, especially meat products, in pieces of predetermined weight and dimensions, such as quadratic pieces of meat, where the cutting is effected in two cutting stages, where the first stage prepares the item by cutting the item into parts, which in the second cutting stage are cut into pieces of predetermined weight and dimension.

The method preferably comprises the following stages:
transport of the items in a first feeding direction in a first cutting arrangement, in which arrangement the items are cut-up into strips in a cutting unit,
transfer of the strips from the first cutting arrangement to one or more further cutting arrangements with second/other feeding direction/feeding directions different from the first feeding direction, and
cutting-up in the one or more further cutting arrangements, in which further cutting arrangement/arrangements the strips are cut in a cutting unit into pieces of predetermined weight and dimensions, such as rectangular meat pieces.

There is hereby provided a method which makes it possible to perform a cutting-up into said mentioned portions, and this is effected in both a quick and profitable manner by an automation of the hitherto manual process. With the invention, there can be achieved an improvement in efficiency from the present few pieces per hour with the manual cutting to more than 1000 per minute by use of the three additional cutting units

In a preferred example embodiment, in the first cutting device there is carried out a first measuring of the shape, structure and/or dimension of the food item. It is hereby made possible that a scanning of the shape/structure of the food item can form the basis for a planning of the cutting profile, and that the cutting can be carried out in accordance with this profile and direct the strips to the additional cutting device or devices. Moreover, preferably in the one or more additional cutting devices, there is performed a further measurement of the shape, structure and/or dimension of the strip. It is herewith possible to verify or correct the first measurement from the first cutting device for a possible alteration of the cutting profile for the additional cutting device(s).

In a preferred embodiment, in connection with the first measurement and on the basis of predetermined dimensions and/or weight of the pieces, a cutting profile is determined where at least a part of this cutting profile is carried out by the first cutting device. The dimensions and/or the weight of the strips and the cutting-up of these can herewith be precisely determined, and the cutting profile of this can be planned on the basis of the shape/appearance of the food item. The food item is preferably pre-cut to an approximately rectangular shape, which makes it relatively simple to determine a cutting profile for the item. The first cutting device can herewith be provided with a control programme which plans the whole of the cutting sequence, i.e. also the cutting-up in the remaining cutting units.

In an example embodiment, at least a part of said cutting profile is communicated further to the additional cutting device(s). By a simple appropriate programming of just one of the cutting devices, the whole of the cutting profile for the food items can herewith be communicated further for execution by the additional cutting devices.

In an example embodiment, two or more of the other feeding directions lie substantially parallel with one another, and in another embodiment one or more of the feeding directions lie substantially at right-angles to the first feeding direction. Rectangular, quadratic pieces can hereby be produced in a simple manner solely by a simple transfer of the strips between the first and the additional cutting device(s).

The method preferably comprises manual positioning of the food items in the first cutting device, and/or manual transfer of the strips to one or more of the additional cutting devices. By the placing of items or transfer of strips either “by eye” or on the basis of a planned portion-cutting-profile, each operator can place each item/strip in/for the cutting device.

In another example embodiment, the method further comprises non-manual placing of the food items in the first cutting device and/or non-manual transfer of the strips to one or more of the additional cutting devices. Automatically and without the need for manual positioning, there can hereby be achieved an appropriate placing for cutting into pieces with predetermined dimensions and weight.

In a second aspect of the invention, there is provided an arrangement for portion-cutting of food items, especially meat products, in pieces of predetermined weight and dimensions, such as quadratic pieces of meat, comprising a first cutting device which comprises a cutting unit for the cutting of the food items into strips during the transport in a first feeding direction, one or more additional cutting devices, each comprising a cutting unit for the cutting of the strips into pieces of predetermined weight and dimensions, such as quadratic pieces of meat, during transport in other feeding directions different from the first feeding direction and after transfer. The arrangement can herewith expediently carry out a precise and profitable portion-cutting, such as e.g. the special cutting of pieces of predetermined dimensions/weight. Moreover, the arrangement can make it possible that known cutting devices can be used in the setting-up of the arrangement, which makes the overall arrangement relatively cheap in development costs.

A second aspect of the invention comprises the use of a cutting device in an arrangement according to the invention, and with one use the said cutting device is arranged to send at least a part of the cutting profile further to other cutting devices. The two or more cutting devices, which are in an arrangement according to the invention, can herewith mutually communicate between or from the processor means.

In the following, the invention is described in more detail with reference to the enclosed drawing, where

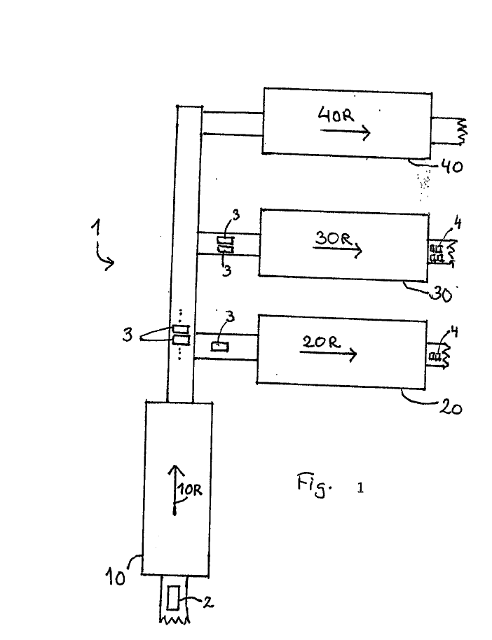

FIG. 1 shows an arrangement in one embodiment of the invention.

From Danish utility model no. DK 96 00164 U3, a cutting apparatus is known for portion cutting of food items. Herein there is described a machine for portion cutting of food items which comprises a cutting unit for the cutting of the items, which by a first and second conveyor respectively are fed past the cutting unit. A scanning system for detecting the shape of the items is arranged at the first conveyor. The shape of the items is registered in computer means which, on the basis of the shape of the items and control of the transport speed of the first conveyor, can control the machine for the portion cutting of the items with a predetermined weight, length or size.

As will appear from FIG. 1, in one embodiment of the invention an arrangement 1 for portion cutting of food items 2 into quadratic portions 4, especially meat products, comprises four cutting devices 10, 20, 30, 40, where a first cutting device 10 cuts the food items 2 into strips 3 and has three further cutting devices 20, 30, 40 placed downstream of said first cutting device for the cutting of the strips 3 into quadratic meat pieces 4, which can be sent further (not shown) for additional pre-processing, such as further cutting, packing and/or storage. These cutting devices can be of the type described in DK 96 00164 U3, but can naturally also be of another type, possibly with other forms of cutting units or scanning means, and the computer means can be individual for each individual cutting device or can be common to them all, possibly in communication with one another.

The expression strips 3 is to be understood to comprise a cut-up food item which, independent of the thickness of the item, is a strip of varying width.

As shown in FIG. 1, the first cutting device 10 has a first feeding direction indicated by an arrow 10R, and the three further cutting devices 20, 30, 40 have other feeding directions indicated respectively by the arrows 20R, 30R and 40R, where the other feeding directions lie parallel with one another and at right-angles to the feeding direction 10R, i.e. that they lie with feeding directions which are different from the first feeding direction 10R. It is obvious that if one can envisage that the other feeding directions 20R, 30R and 40R lie turned 180 degrees in relation to the first feeding direction 10R, they will also lie with feeding directions which differ from the first feeding directions 10R.

The transfer of strips 3 between the first cutting device 10 and one or more of the subsequent cutting devices 20, 30, 40, which extend in a substantially parallel manner, can for example with said special portion cutting expediently be carried out manually in accordance with a planned portion-cutting profile on the basis of the measurement from the scanning means and/or be carried out “by eye”. Alternatively, transfer means such as conveyors with deflector means can be placed where the transfer and therewith the placing of the strip in the one or more of the further cutting devices is possibly controlled by the portion-cutting arrangement's computer means.

The placing of the food item 2 at the feed-in to the first cutting device 10 is of importance for the scanning and the planning of the portion-cutting profile, which is carried out by the processing means on the basis of predetermined requirements and dimensions and/or weight of the meat pieces 4 submitted to the computer. A manual placing based on the shape of the item can further increase the accuracy of the arrangement and reduce the percentage of wastage, for the reason that the output item can as mentioned be uniform in shape, thickness and width. A placing of the items based on scanning and transfer of each of the items/strips 2,3 is naturally also an obvious possibility.

The four cutting devices 10, 20, 30, 40 are placed in relation to one another in such a manner that the first cutting device 10 can receive the food items 2 to be cut, for the scanning and cutting of these into strips, which individually or several together are transferred to each of the three further cutting devices 20, 30, 40.

With the invention it is realised that two or more of the further cutting devices can be cutting devices 30 with two or more tracks, as shown in the figure.

The said special portion-cut items have dimensions with a length of less than twice the width and height, approx. 25×25 mm and a weight of around 18-32 g, but others can naturally be defined by the arrangement according to the invention.

In an arrangement according to a preferred embodiment of the invention, with a set-up which resembles that shown in FIG. 1, but without the cutting device 40, 130 items per minute can be cut on the cutting device 10, and thereafter the strips shall be distributed in three lines with 1-track cutting device 20 and a 2-track cutting device 30. When the 130 original items have such a size that they can each be cut into three strips 4, they become 390 strips in all. If the strips are distributed on the three tracks in a uniform manner, they become 130 strips per track per minute. When these strips can each be cut into three quadratic pieces, they become 1170 diced items per minute for three lines. If these diced items each weigh 22 g, the collective result is 25.74 kg per minute, which corresponds to 1544 kg per hour. On this basis it is calculated collectively that said arrangement can save 8 operators.

1-21. (canceled)

22. A method for portion cutting a food item, comprising the steps of:
cutting the food item into parts at a first cutting stage;
cutting the parts into pieces of predetermined weight and dimension at a second cutting stage;
scanning at least one of a shape, a structure and a dimension of the food item at the first cutting stage by a measuring means; and
determining a portion-cutting profile in connection with said scanning and on the basis of predetermined dimension and/or weight of the pieces by a processor means.

23. A method for portion cutting a food item as set forth in claim 22, whereby said determining said portion-cutting profile comprises the step of planning the whole of a cutting sequence.

24. A method for portion cutting a food item as set forth in claim 22, whereby at least a part of said portion-cutting profile is carried out in said first cutting stage.

25. A method for portion cutting a food item as set forth in claim 22, further comprising the steps of:
feeding the item into a first cutting device, in which device the item is cut into strips in a cutting unit;
transferring the strips from the first cutting device to one or more additional cutting devices; and
cutting in the one or more additional cutting devices, in which the strips are cut into pieces of predetermined shape.

26. A method for portion cutting a food item as set forth in claim 25, whereby other scanning of the shape, structure and/or dimension of the strips is performed in the one or more additional cutting devices.

27. A method for portion cutting a food item as set forth in claim 25, whereby a feeding direction of said one or more additional cutting devices is different from that of said first cutting device.

28. A method for portion cutting a food item as set forth in claim 25, whereby at least a part of said portion-cutting profile is communicated further to one or more of the additional cutting devices.

29. A method for portion cutting a food item as set forth in claim 25, wherein the feeding directions for two or more additional cutting devices lie substantially parallel with one another.

30. A method for portion cutting a food item as set forth in claim 25, wherein a feeding direction for the one or more additional cutting devices lies substantially at right-angles to a feeding direction for the first cutting device.

31. A method for portion cutting a food item as set forth in claim 25, further comprising the step of manually placing the food item in the first cutting device and/or manually transferring the strips to one or more of the additional cutting devices.

32. A method for portion cutting a food item as set forth in claim 25, further comprising the step of non-manually placing the food item in the first cutting device and/or non-manually transferring the strips to one or more of the additional cutting devices.

33. An apparatus for portion cutting a food item comprising:
a first cutting device which comprises a cutting unit for cutting the food item into strips; and
one or more additional cutting devices, each comprising a cutting unit for cutting the strips into pieces of predetermined weight and dimensions, wherein measuring means are arranged in the first cutting device for scanning at least one of a shape, a structure and a dimension of the food item, and wherein said apparatus further comprises processor means with a control program for the planning of a portion-cutting profile on the basis of said scanning.

34. An apparatus for portion cutting a food item as set forth in claim 33, wherein said processor means are arranged to plan the whole of a cutting sequence, and thereby establish said portion-cutting profile.

35. An apparatus for portion cutting a food item as set forth in claim 33, wherein said first cutting device is adapted to carry out at least a part of said portion-cutting profile.

36. An apparatus for portion cutting a food item as set forth in claim 33, wherein further measuring means are arranged in said one or more additional cutting devices for scanning at least one of a shape, a structure and a dimension of said strips.

37. An apparatus for portion cutting a food item as set forth in claim 33, wherein the processor means are arranged to send at least a part of the portion cutting profile further to the one or more additional cutting devices.

38. An apparatus for portion cutting a food item as set forth in claim 33, which further comprises transfer means for transferring one or more of the strips from the first cutting device to the one or more additional cutting devices.

39. An apparatus for portion cutting a food item as set forth in claim 33, which further comprises placing means for placing the food item in the first cutting device.

40. An apparatus for portion cutting a food item as set forth in claim 33, wherein a feeding direction of said one or more additional cutting devices is different from that of said first cutting device.
